(19) United States
(12) Patent Application Publication
(10) Pub. No.: US 2006/0139129 A1
(43) Pub. Date: Jun. 29, 2006

(54) Waveguide filter

(75) Inventors: Thomas Johannes Mueller, Erbach-Bach (DE); Marcus Baertele, Ulm (DE)

Correspondence Address: CROWELL & MORING LLP;INTELLECTUAL PROPERTY GROUP, P.O. BOX 14300, WASHINGTON, DC, 20044-4300, US

(73) Assignee: EADS Deutschland GmbH, Ottobrunn (DE)

(21) Appl. No.: 10/528,426

(22) PCT Filed: Jul. 30, 2003
(86) PCT No.: PCT/DE03/02552

§ 371 Date: Dec. 6, 2005

(30) Foreign Application Priority Data
Sep. 20, 2002 (DE) 102 43 670.3

(51) Int. Cl. H01P 1/211

(52) U.S. Cl. 333/208; 333/210

(57) ABSTRACT

A waveguide filter formed from a substrate (S), which is coated on the upper face with a structured metallic layer (TM) and one or more metallic striplines (ML1, ML2), and a component (FB) fitted to the upper face of the substrate (S) and with one side wall of the waveguide filter being formed by the structured metallic layer (TM) of the substrate (S). The other side walls of the waveguide filter are formed by the component (FB), and with the waveguide filter having input and output points for coupling the electromagnetic waves carried in the stripline (ML1, ML2) to the waveguide filter, and vice versa.

This application claims priority to International Patent Application No. PCT/DE2003/002552, filed Jul. 30, 2003, designating the United States of America, and German Application DE 102 43 670.3-35, filed Sep. 20, 2002, the disclosure(s) of which is (are) expressly incorporated by reference herein.

### BACKGROUND AND SUMMARY OF THE INVENTION

The invention relates to a waveguide filter.

Waveguide filters are conventional components for microwave and millimetric wave technology. This filter type normally has relatively high resonator Q-factors and narrow electrical tolerances for the passband and cutoff band. Waveguide filters are distinguished by high stop-band attenuations and a low insertion loss. Waveguide filters are preferably used where it is no longer possible to use planar filters owing to stringent requirements for the electrical tolerance accuracy and the Q-factor.

An arrangement for frequency-selective suppression of radio-frequency signals is known from German Application DE 197 57 892 A1. The arrangement in this case has a baseplate with a first and a second substrate surface, each having a coupling connection and each having an electrically conductive panel. A shroud which is arranged over the baseplate, together with the electrically conductive panel, forms a hollow chamber which acts as a cavity resonator. The cavity resonator acts as a high-pass filter, so that the only frequencies which can propagate are those which are higher than a cutoff frequency that is determined by the geometric dimensions of the cavity resonator.

A further known filter is known from U.S. Pat. No. 6,236,291 B1. A housing which, together with the upper face of the substrate, forms a cavity, is arranged on the upper face of a substrate whose lower face is completely metallically coated. A dielectric panel which acts as a dielectric filter is arranged in this cavity.

FIG. 1 shows a further possible arrangement. The illustration shows the integration of a waveguide filter in a planar circuit according to the prior art. The arrangement comprises a substrate S which has a first stripline ML1 and a second stripline ML2, for example a microstripline, on the upper face. The first stripline ML1 is in this case used for inputting the transported electromagnetic wave into the waveguide filter HF, and the second stripline ML2 is used for outputting the wave from the waveguide filter HF. Input and output points are provided at the two ends of the filter for inputting/outputting the signal from/to the stripline, in order to change the signal from the mode which can propagate on the stripline to the waveguide mode which can propagate in the filter, and vice versa.

These coupling points are formed at both ends of the filter from the striplines ML1, ML2, the substrate S, the shielding-cap SC, the via holes VH, the rear aperture face body RM and the baseplate TP with the cap DB.

The striplines ML1, ML2 each end underneath a shielding SC, which is used to prevent radiated emission of electromagnetic waves to the surrounding area. Rear-face metallization RM, which has an aperture DB in the area of the shielding cap, is located on the lower face of the substrate S. A metallic baseplate TP is arranged on the lower face of the substrate and likewise has an aperture DB in the area of the shielding cap, so that the two apertures in the rear-face metallization of the substrate and in the baseplate TP are aligned with one another. The waveguide filter HF is screwed to this baseplate TP, with each of the openings in the waveguide filter being connected to the apertures DB.

An electromagnetic wave passes from the first stripline ML1 through the substrate S and the aperture DB into the waveguide filter HF. The electromagnetic wave is then passed from the waveguide filter HF through the apertures DB to the second stripline ML2.

One disadvantage of the integration of a conventional waveguide filter in a stripline environment (for example on printed circuits) is the high costs associated with this which, until now, have prevented widespread use of this principle. The cost drivers in this area are the large number of manufacturing steps and components, and the necessity to fit components on the front face and rear face of the substrate.

The waveguide junction requires a precision-manufactured, mechanically accurately positioned shielding cap SC. The metallization on both faces of the substrate S must be structured with a small offset between the conductor track patterns on the lower face and upper face. The aperture DB in the baseplate must be produced in an additional manufacturing step. The substrate S must be connected to the baseplate TP conductively and accurately positioned. A shielding cap, which must be produced as a separate component, must be fitted to the substrate S conductively and accurately positioned.

The waveguide filter HF normally comprises two parts (a waveguide filter lower part with three side walls of the waveguide filter and a cover part as a fourth side wall of the waveguide filter) which must be produced separately and must first of all be joined. The joined filter must then be attached to the lower face of the baseplate, such that it is accurately positioned.

Further disadvantages result from the fact that the waveguide filter normally has a number of components (shielding cap, baseplate, waveguide filter) and that this type of implementation occupies a large amount of space.

The object of the invention is to provide a waveguide filter which can be adapted to a printed circuit board easily, at low cost and in a space-saving manner.

According to the invention, the waveguide filter is formed from a substrate, coated on the upper face with a structured metallic layer and one or more metallic striplines, and a component fitted to the upper face of the substrate. One side wall of the waveguide filter is formed by the structured metallic layer of the substrate, and the other side walls of the waveguide filter are formed by the component. The waveguide filter has input and output points for coupling the electromagnetic waves carried in the stripline to the waveguide filter, and vice versa.

One advantage of the waveguide filter according to the invention is that essentially includes a single component which can be produced easily and at low cost and is fitted to the upper face of an appropriately previously structured substrate. The waveguide filter is, in this case, not formed by the component or the substrate per se, but only by the arrangement of the two elements with respect to one another according to the invention.

The component can advantageously be a surface mounted device. A large number of the components used on a printed circuit board are normally surface mounted devices. The waveguide filter surface mounted device according to the invention can expediently be included in the manufacturing process. The assembly can be populated from just one side. This results in further advantages in terms of manufacturing costs and time.

The component, which is also referred to as the filter upper part, advantageously has a conductive surface and may, for example, be produced from metal or metallized plastic, with the latter resulting in further advantages in terms of production costs and weight. The filter upper part is advantageously conductively connected to the substrate, in particular with the filter upper part being soldered or conductively adhesively bonded to the substrate.

In one advantageous embodiment of the invention, the filter upper part is structured on the side wall which is opposite the upper face of the substrate (that is to say the substrate face to which the filter upper part is attached). This structure can then be predetermined, depending on the desired waveguide filter characteristics. The cross section of the waveguide filter can advantageously be chosen to correspond to the radio-frequency signal to be filtered.

### BRIEF DESCRIPTION OF THE DRAWINGS

The invention as well as further advantageous embodiments will be explained in more detail in the following text with reference to drawings, in which:
FIG. 1 shows a waveguide filter, fitted to a substrate, according to the prior art,
FIG. 2 shows a plan view of the filter upper part with a structured internal surface,
FIG. 3 shows a longitudinal section through the filter upper part along the section line A-A′ in FIG. 2,
FIG. 4 shows a plan view of the metallized layer on the upper face of the substrate, and
FIG. 5 shows a cross section through an arrangement according to the invention of a waveguide filter comprising a substrate and a filter upper part, along the section line B-B′ in FIG. 2 and FIG. 4.

### DETAILED DESCRIPTION OF THE DRAWINGS

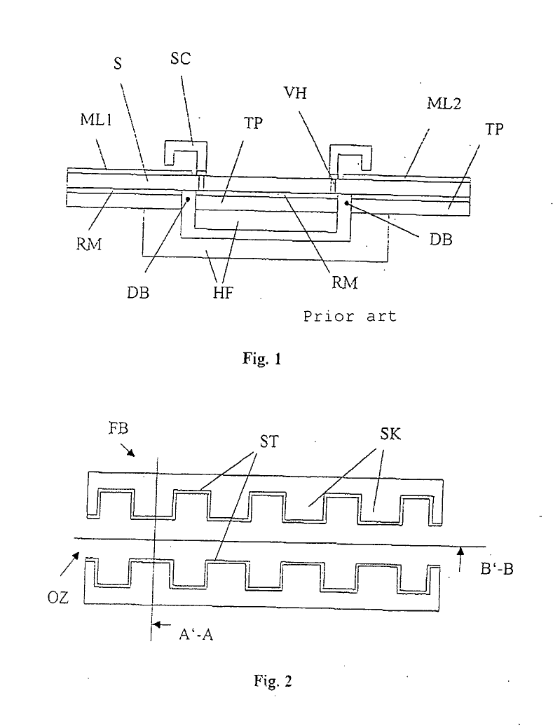

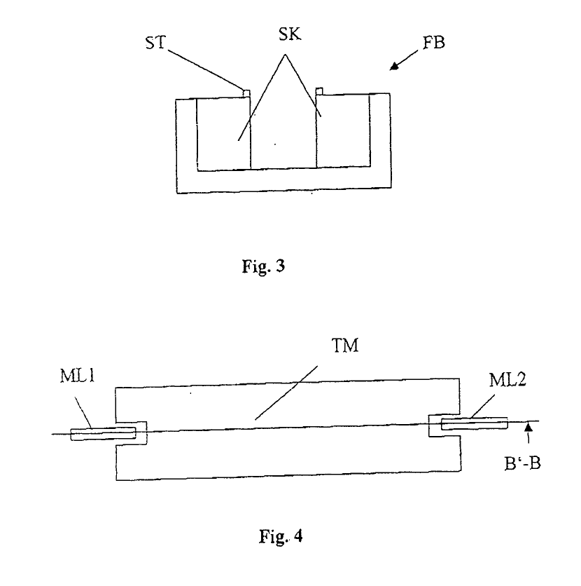

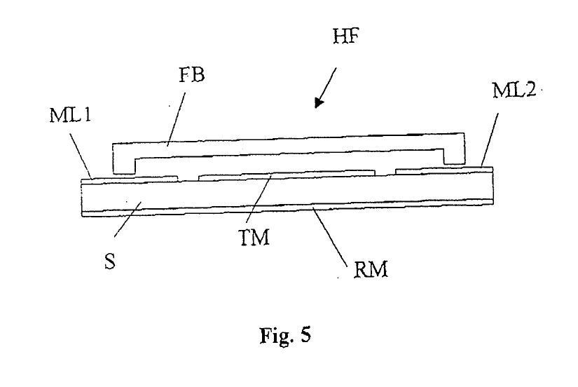

FIG. 2 shows a plan view of the filter upper part with a structured inner surface. At each of its opposite ends, the filter upper part FB has an opening OZ through which the microstriplines (see FIG. 4 and FIG. 5) are passed into the waveguide filter. The filter upper part FB is essentially U-shaped (see FIG. 3) and has a structure SK in the interior. The structure SK is in this case advantageously chosen to correspond to the desired waveguide filter characteristics.

Manufacturing methods such as milling or plastic injection molding can be used to produce mechanically high-precision structures SK, so that the waveguide filter also, in a corresponding manner, has only minor electrical tolerances for the input and filter function.

Furthermore, the filter upper part FB advantageously has a circumferential web ST (FIG. 2 and FIG. 3). In the waveguide filter, this web ST is seated directly on the metallized upper face of the substrate (not shown). This web ST is expediently adapted for the respective joining method that is used. The conductive solder or the conductive adhesive can be distributed in the space formed between the filter upper part and the substrate when they are joined together, thus ensuring an optimum connection.

The web ST can expediently be adapted such that, for example when the joining method is “soldering”, the surface tensions which occur in the solder during the soldering process can be used to ensure that the component FB is positioned exactly on the metallically structured layer illustrated in FIG. 4 during the soldering process.

FIG. 3 shows a section illustration of the filter upper part along the section line A-A′ in FIG. 2. The illustration shows the essentially U-shaped filter upper part FB with the internal structure SK. The structure SK is in this case illustrated only by way of example. Other structure forms are, of course, also possible depending on the application.

FIG. 4 shows a plan view of the metallized upper face of the substrate, to which the filter upper part can be fitted in order to form the waveguide filter according to the invention. In this case, ML1, ML2 denote the striplines, and TM denotes the metallization, which forms one wall of the waveguide filter in the arrangement according to the invention. The striplines ML1, ML2 may, for example, be microstriplines and are used for inputting and outputting the electromagnetic waves into and out of the waveguide filter.

FIG. 5 shows a section illustration along the section line B-B′ from FIG. 2 and FIG. 4 for a waveguide filter arrangement according to the invention. The waveguide filter HF is formed by the filter upper part FB, as illustrated in FIG. 2, being fitted with high-precision to the metallized upper face TM of the substrate S, as illustrated in FIG. 4.

The striplines ML1, ML2 which are formed on the upper face of the substrate S lead from the outside into the internal area of the waveguide filter HF. The metallization TM on the upper face of the substrate S forms the fourth wall, according to the invention, of the waveguide filter HF. The other side walls of the waveguide filter HF are formed by the filter upper part FB.

1. A waveguide filter comprising a substrate (S), coated on at least a portion of upper face with a structured metallic layer (TM).
at least one metallic stripline for carrying electromagnetic waves, and
a component fitted to the upper face of the substrate (S), wherein one side wall of the waveguide filter is formed by the structured metallic layer (TM) on the substrate (S), and wherein other side walls of the waveguide filter are formed by the component (FB); said waveguide filter having input and output points for coupling the electromagnetic waves carried between the at least one metallic strip lines and an internal portion of the waveguide filter.

2. The waveguide filter as claimed in claim 1, wherein the component (FB) is a surface mounted device.

3. The waveguide filter as claimed in claim 2, wherein the component (FB) has a circumferential web (ST) which rests on the structured metallic layer (TM) on the upper face of the substrate (S).

4. The waveguide filter as claimed in claim 1, wherein a cross section of the component (FB) is chosen in accordance with predeterminable filter characteristics of the waveguide filter (HF).

5. The waveguide filter as claimed in claim 1, wherein a side wall of the component (S) which is opposite the upper face of the substrate (S) has a structure (SK) which can be predetermined for corresponding appropriate filter characteristics.

6. A waveguide filter, comprising:
a substrate at least partially coated with a structured metallic layer,
a surface mounted device fitted on said structured metallic layer and forming a plurality of surfaces of said waveguide fitter,
at least one metallic stripline formed on said substrate for carrying electromagnetic waves.

7. The waveguide filter as claimed in claim 6, wherein the component (FB) has a circumferential web (ST) which rests on the structured metallic layer (TM) on the upper face of the substrate (S).

8. The waveguide filter as claimed in claim 6, wherein a cross section of the component (FB) is chosen in accordance with predeterminable filter characteristics of the waveguide filter (HF).

9. The waveguide filter as claimed in claim 6, wherein a side wall of the component (S) which is opposite the upper face of the substrate (S) has a structure (SK) which can be predetermined for corresponding appropriate filter characteristics.

10. The waveguide filter as claimed in claim 2, wherein a cross section of the component (FB) is chosen in accordance with predeterminable filter characteristics of the waveguide filter (HF).

11. The waveguide filter as claimed in claim 3, wherein a cross section of the component (FB) is chosen in accordance with predeterminable filter characteristics of the waveguide filter (HF).

12. The waveguide filter as claimed in claim 2, wherein a side wall of the component (S) which is opposite the upper face of the substrate (S) has a structure (SK) which can be predetermined for corresponding appropriate filter characteristics.

13. The waveguide filter as claimed in claim 3, wherein a side wall of the component (S) which is opposite the upper face of the substrate (S) has a structure (SK) which can be predetermined for corresponding appropriate filter characteristics.

14. The waveguide filter as claimed in claim 4, wherein a side wall of the component (S) which is opposite the upper face of the substrate (S) has a structure (SK) which can be predetermined for corresponding appropriate filter characteristics.
